(19) United States
(12) Patent Application Publication
(10) Pub. No.: US 2012/0127464 A1
(43) Pub. Date: May 24, 2012

(54) LIGHT SOURCE APPARATUS

(75) Inventors: Makoto Oigawa, Kawasaki-shi (JP); Minoru Yoshii, Tokyo (JP)

(73) Assignee: CANON KABUSHIKI KAISHA, Tokyo (JP)

(21) Appl. No.: 13/292,876

(22) Filed: Nov. 9, 2011

(30) Foreign Application Priority Data
Nov. 22, 2010 (JP) 2010-260528

(51) Int. Cl. G01J 3/44; H01S 3/10; H01S 3/098; G01B 9/02

(52) U.S. Cl. 356/301; 356/479; 372/20; 372/18

(57) ABSTRACT

A light source apparatus that emits pulsed light includes an optical resonator and a modulator. The optical resonator has an optical gain medium that amplifies light and an optical waveguide. The modulator modulates an intensity of the light in the optical resonator. The optical resonator with the optical gain medium includes a plurality of optical resonators having different optical path lengths from each other to make a difference between intervals of free spectral ranges in the plurality of optical resonators, to reduce a spectral line width of the pulsed light compared to that of a light source apparatus separately using the plurality of optical resonators as an individual optical resonator, the spectral line width determined by an envelope formed by a sideband wave of an oscillation mode which is generated by the modulation.

### BACKGROUND OF THE INVENTION

1. Field of the Invention

The present invention relates to a light source apparatus configured to emit pulsed light with a reduced spectral line width.

2. Description of the Related Art

In recent years, various wavelength tunable light sources have been developed as a light source for use in various kinds of optical measurement. Especially, a light source having a wide wavelength tunable band and a high wavelength tuning speed is widely demanded to be developed, since it can contribute to improving the performance of a measurement apparatus.

Examples of other desired features include a reduction in a spectral line width (hereinafter also referred to as just “line width”) at the time of oscillation. This is because optical measurement with use of a wavelength tunable light source can have enhanced resolution and an improved Signal-to-Noise ratio (SN ratio) by a reduction in the spectral line width at the time of measurement at each wavelength.

Under these circumstances, S. Yamashita, et al, Optics Express Vol. 14, pages 9299 to 9306 (2006) discusses a dispersion tuning method as a light source capable of tuning a wavelength throughout a wide band at a high speed. This method utilizes the fact that a free spectral range (hereinafter also referred to as “FSR”) varies according to a wavelength when a reflective index is subject to chromatic dispersion in an optical resonator, i.e., chromatic dispersion occurs in an optical resonator.

More specifically, S. Yamashita, et al, Optics Express Vol. 14, pages 9299 to 9306 (2006) discusses a method of changing an oscillation wavelength by changing a modulation frequency (which varies depending on an FSR), by utilizing the feature of active mode locking that a modulation frequency varies according to a central wavelength of laser oscillation.

On the other hand, U.S. Pat. No. 6,141,360 discusses a technique for reducing a line width. More specifically, U.S. Pat. No. 6,141,360 discusses a technique of providing a plurality of optical resonators for a single gain medium, causing oscillation at a position where longitudinal modes allowed by the respective resonators overlap, and to reduce an oscillation spectral line width compared to a method using a single resonator.

The method of tuning a wavelength by dispersion tuning, which is discussed in S. Yamashita, et al, Optics Express Vol. 14, pages 9299 to 9306 (2006), utilizes an active mode locking operation in principle. Therefore, generated light is pulsed light. In other words, generated light is a wave packet with overlapping sideband waves (hereinafter also referred to as “sideband”) excited by the modulation.

As a result, an increase in the line width cannot be avoided compared to single-wavelength continuous oscillation light (hereinafter also referred to as “CW (Continuous Wave) light”), and the sideband is always present according to the operating principle, so that, actually, a reduction in the line width is fundamentally difficult.

On the other hand, the method of reducing a line width with use of a plurality of resonators, which is discussed in U.S. Pat. No. 6,141,360, aims at a reduction in a line width of continuous oscillation light in the first place, and does not mention application of this method to a light source apparatus for pulsed oscillation.

### SUMMARY OF THE INVENTION

The present invention is directed to a light source apparatus capable of achieving a high-speed sweep of an oscillation wavelength of pulsed light and a reduction in a line width of an oscillation spectrum at the same time.

According to an aspect of the present invention, a light source apparatus includes an optical resonator including an optical gain medium configured to amplify light and an optical waveguide, and a modulator configured to modulate an intensity of the light in the optical resonator. The light source apparatus is configured to emit pulsed light from the optical resonator. The optical resonator provided with the optical gain medium includes a plurality of optical resonators having different optical path lengths from each other to make a difference between intervals of free spectral ranges in the plurality of optical resonators, to reduce a spectral shape of the pulsed light, which is determined by an envelope formed by a sideband wave of an oscillation mode which is generated by the modulation, compared to a light source apparatus separately using the plurality of optical resonators as an individual optical resonator.

According to the present invention, the light source apparatus, which emits pulsed light, includes the optical resonator constituted by the plurality of optical resonators having optical path lengths different from each other, to make a difference between the intervals of the free spectral ranges in the plurality of optical resonators. As a result, it is possible to narrow the spectral shape of the pulsed light determined by the envelope constituted by the sideband wave of the oscillation mode, which is generated by the modulation, compared to that of a light source apparatus separately using the plurality of optical resonators as an individual optical resonator. According to the present invention, it is possible to generate pulsed light with a reduced line width by a mode locking operation with use of a simple method.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 schematically illustrates a light source apparatus according to an exemplary embodiment of the present invention.

FIG. 2 schematically illustrates a light source apparatus constructed using a single optical resonator.

FIG. 3 schematically illustrates longitudinal modes of the optical resonator during an active mode locking operation.

FIGS. 4A, 4B, and 4C schematically illustrate FSRs in an optical resonator constructed using a plurality of optical waveguides having different optical path lengths.

FIGS. 5A and 5B each schematically illustrate an envelope of pulsed light during an active mode locking operation.

FIG. 6 schematically illustrates a light source apparatus according to an exemplary embodiment the present invention.

FIG. 7 schematically illustrates a light source apparatus constructed using a single optical resonator.

FIG. 8 is a graph illustrating a spectrum of pulsed light acquired by an active mode locking operation using a signal optical resonator.

FIG. 9 schematically illustrates a light source apparatus according to an exemplary embodiment of the present invention.

FIG. 10 schematically illustrates a light source apparatus according to an exemplary embodiment of the present invention.

FIG. 11 schematically illustrates an optical coherence tomography using the light source apparatus according to the exemplary embodiment of the present invention.

FIG. 12 schematically illustrates a stimulated Raman scattering microscope apparatus using the light source apparatus according to the exemplary embodiment of the present invention.

### DESCRIPTION OF THE EMBODIMENTS

Various exemplary embodiments, features, and aspects of the invention will be described in detail below with reference to the drawings.

The present invention has been contrived based on such a discovery by the inventors that it is possible to reduce a spectral line width of pulsed light during an active mode locking operation by constructing a single resonator using a plurality of resonators having slightly different optical path lengths.

In the following, an exemplary embodiment for carrying out the present invention will be described. A light source apparatus according to the present exemplary embodiment of the present invention, which emits pulsed light by a forced mode locking operation, includes an optical resonator including an optical gain medium for amplifying light and an optical waveguide, and a modulator for modulating a light intensity in the optical resonator.

The optical resonator, which includes the optical gain medium, is constituted by a plurality of optical resonators having optical path lengths different from each other, to make a difference between the intervals of the free spectral ranges (FSRs) in the plurality of optical resonators. As a result, the light source apparatus can be configured to narrow the spectral shape of the pulsed light determined by an envelope constituted by a sideband wave of an oscillation mode, which is generated by modulation, compared to a light source apparatus separately using the plurality of optical resonators as an individual optical resonator.

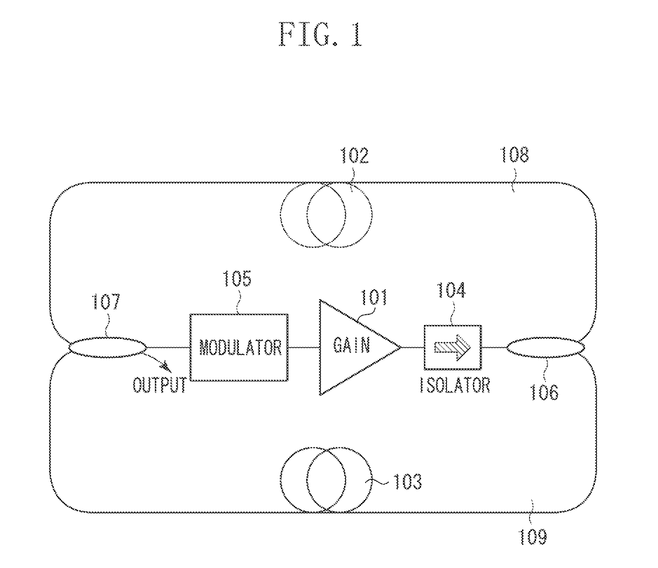

FIG. 1 schematically illustrates an example of a light source apparatus according to the present exemplary embodiment.

In the light source apparatus illustrate in FIG. 1, optical resonators 108 and 109 include an optical gain medium 101, optical waveguides 102 and 103, an optical isolator 104, a modulator 105, a splitting coupler 106, and a multiplexing coupler 107, which are optically connected to one another. The multiplexing coupler 107 also functions as an output coupler. Further, the optical isolator 104 is provided when necessary, and is used to cause light in the ring resonator to travel in one direction to eliminate an influence between opposing modes in the resonator. Further, members indicating a drive system such as a current source for the modulator 105 are omitted from the illustration of FIG. 1.

In this apparatus, the optical resonator 108 including the optical waveguide 102 and the optical resonator 109 including the optical waveguide 103 are configured to have different optical path lengths from each other. As a result, two different kinds of FSR intervals are included in the resonator, and therefore it is possible to acquire pulsed light having a reduced spectral line width, compared to pulsed light generated when an active mode locking operation is performed using a single resonator.

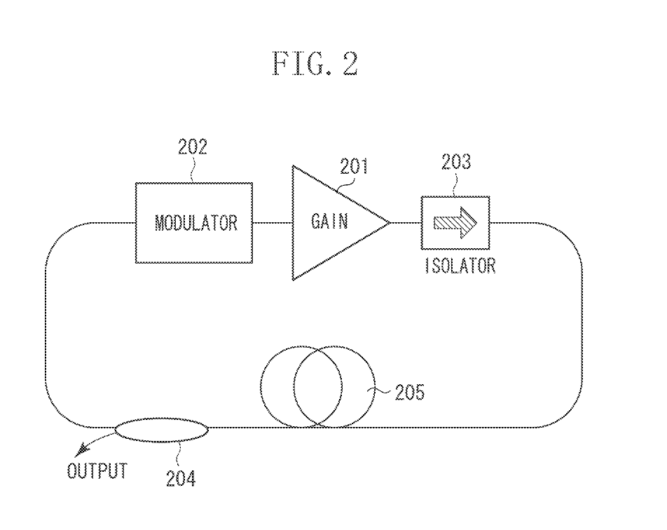

In the following, the operation and function of the light source apparatus according to the present exemplary embodiment will be described. FIG. 2 illustrates a configuration of a light source which performs an active mode locking operation using a single resonator. In the light source illustrated in FIG. 2, the optical resonator includes an optical gain medium 201, a modulator 202, an isolator 203, an output coupler 204, and an optical waveguide 205 which optically connects them.

In this apparatus, optical modes that may exist in the resonator are longitudinal modes located at positions corresponding to FSR intervals determined by the optical path length of the resonator. They are also called resonator modes.

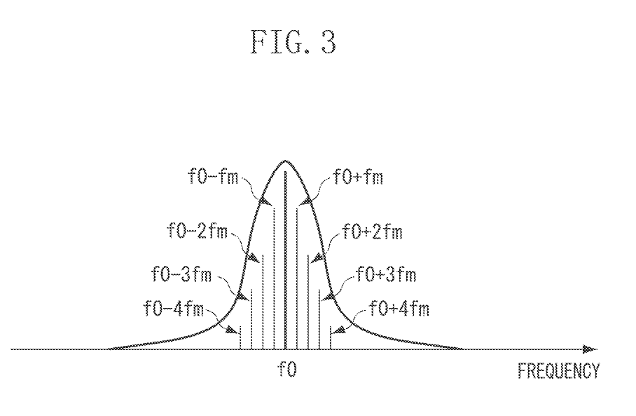

FIG. 3 illustrates longitudinal modes in a frequency space, which exist in the resonator during an active mode locking operation. When light with a frequency of f0 is present, applying modulation to the light in the resonator with a frequency fm, which is equal to an integral multiple of the FSR, results in excitation of sideband waves (sidebands).

Then, among these sidebands and the light of the frequency f0, longitudinal modes in phase overlap each other, to generate pulsed light. This is the active mode locking operation. The spectral line width is the full width at half maximum of the waveform of the pulsed light determined by the envelope of the intensities of the sidebands with the frequency f0 set as the central frequency.

If an optical waveguide constituting a resonator has a constant reflective index, the FSR interval is constant regardless of a wavelength. On the other hand, if a reflective index varies according to a wavelength, i.e., chromatic dispersion occurs, the FSR interval varies according to a wavelength.

Therefore, in terms of the positional relationship on the frequency axis, an increase in the distance from the central frequency f0 increases a difference between the position of a sideband, which is equal to an integral multiple of the modulation frequency (mode locking frequency), and the position of a resonator mode, which is determined by the FSR interval. Therefore, a sideband positioned away from the central frequency f0 has a weak intensity, and a finite number of longitudinal modes (sidebands) overlap each other, resulting in generation of pulsed light in the active mode locking operation.

In other words, sidebands in an active mode locking operation are excited due to the effects of line width roughness and frequency entrainment, even if there is a slight offset between a mode locking frequency and an integral multiple of the FSR interval. As the offset therebetween is increased, the intensity of the sideband is gradually reduced. The present exemplary embodiment positively utilizes this phenomenon, and realizes a reduction in a spectral line width of pulsed light during an active mode locking operation.

This principle will be described in further detail below. Consider a system in which the two resonators 108 and 109 illustrated in FIG. 1 are configured to function as a single resonator for the optical gain medium 101. The optical waveguides 102 and 103 included in the two resonators 108 and 109 are configured to have slightly different optical path lengths.

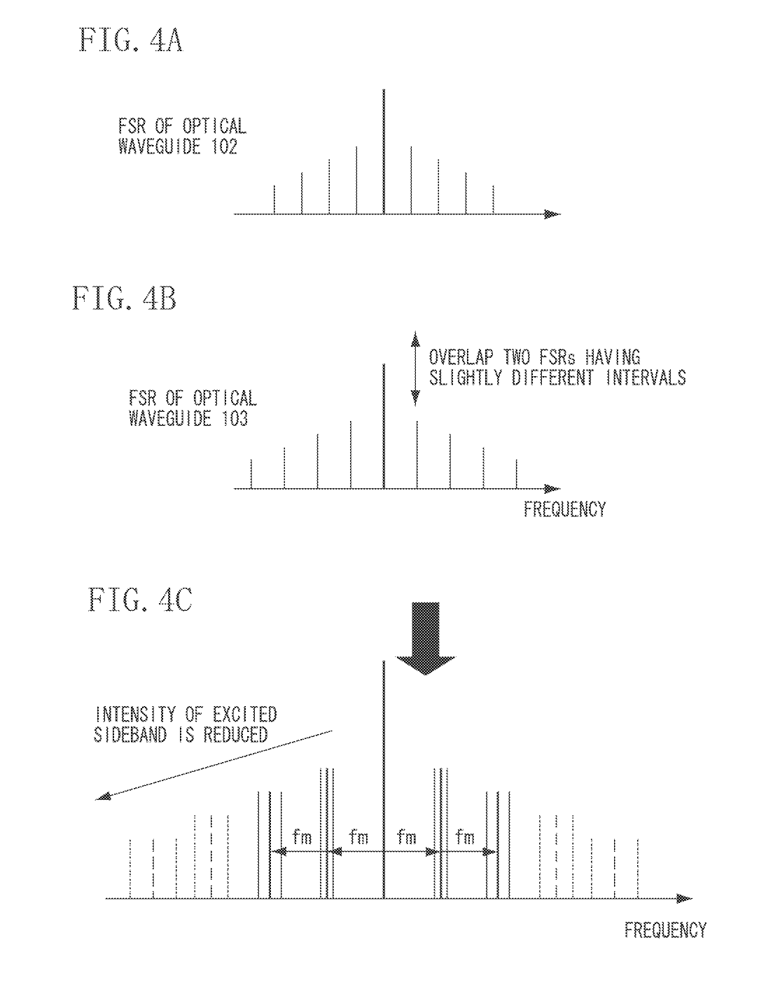

Then, the respective FSR intervals of the two resonators 108 and 109 are slightly different from each other, as illustrated in FIGS. 4A and 4B. FIG. 4C illustrates a result of combining the two resonators as a single resonator.

As illustrated in FIG. 4C, with the center set to a position where the central frequencies f0 of the two resonators 108 and 109 are coincident with each other, an offset between the resonator modes of the resonators 108 and 109 is increased according to an increase in the distance from the center. An active mode locking operation is performed by applying modulation to this resonator with the frequency fm using the modulator 105.

At this time, an intermediate value between the two resonator modes is set as an effective resonator mode, and a sideband is excited at a position where an integer multiple of this effective resonator mode and the mode locking frequency coincides with each other. As the distance from the central frequency f0 is increased, an offset between the two resonator modes is increased, and therefore the intensity of the excited sideband is reduced.

Therefore, as illustrated in FIG. 4C, the intensities of the sidebands are drastically reduced from the position near the central frequency f0. The envelope determined by the intensities of the sidebands has a precipitous drop, compared to that of an active mode locking operation using a single resonator. In this way, a reduction in the spectral line width can be achieved.

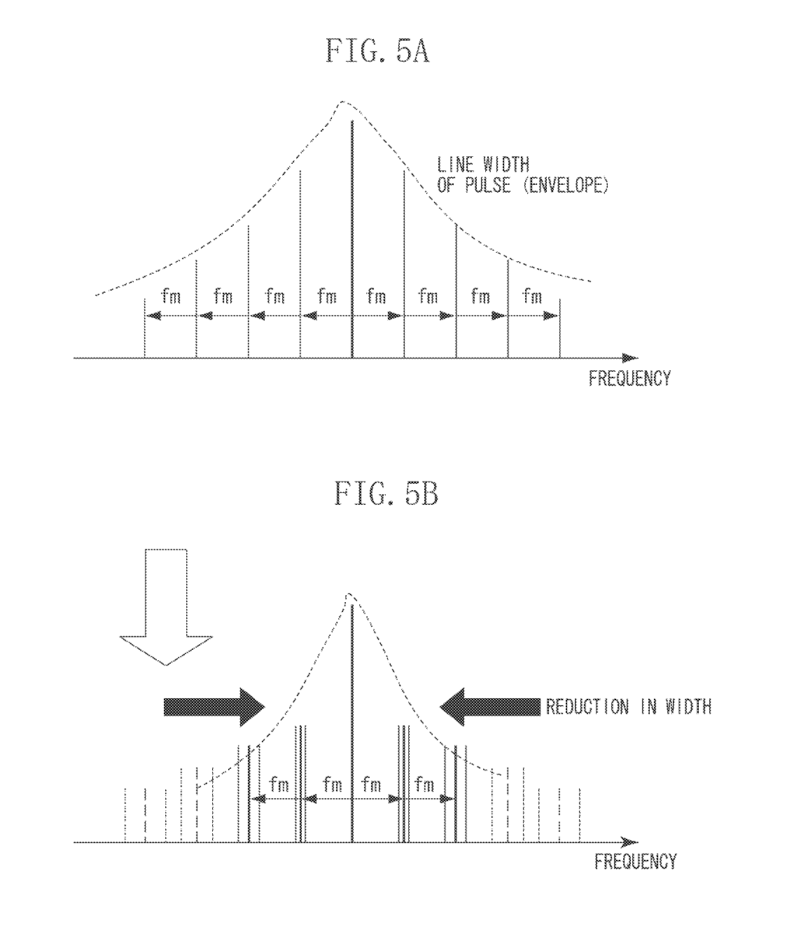

FIGS. 5A and 5B illustrate this phenomenon. FIG. 5A illustrates an envelope of pulsed light expressed on the spectrum, which is generated during an active mode locking operation by a resonator constituted by a single resonator. FIG. 5B illustrates an envelope when a resonator is constituted by a plurality of resonators. As the distance from the central frequency is increased, the intensities of the sidebands are precipitously reduced, to provide a reduction in the line width.

In the present exemplary embodiment, the optical gain medium 101 may be embodied by, for example, a semiconductor optical amplifier (SOA), a rare-earth doped (ion doped) optical fiber containing, for example, erbium or ytterbium, and an optical fiber with dye added thereto for amplifying light by the dye.

Use of a rare-earth doped optical fiber is effective for achieving a high gain and acquiring an excellent noise characteristic. A dye-doped optical fiber can increase the number of choices for tunable wavelength by appropriately selecting, for example, a fluorescent dye material and a host material thereof.

A semiconductor optical amplifier is also an effective choice, due to its small size and its ability to provide high-speed control. Usable types of semiconductor optical amplifier include a reflective optical amplifier and a travelling-wave optical amplifier. A semiconductor optical amplifier may be made of, for example, any compound semiconductor that constructs a commonly-used semiconductor laser device. Specific examples of materials thereof include an indium-gallium-arsenide (InGaAs) compound semiconductor, an indium-arsenide-phosphide (InAsP) compound semiconductor, a gallium-aluminum-antimonide (GaAlSb) compound semiconductor, a gallium-arsenide-phosphide (GaAsP) compound semiconductor, an aluminum-gallium-arsenide (AlGaAs) compound semiconductor, and a gallium-nitride (GaN) compound semiconductor.

The central frequency of a gain of a semiconductor optical amplifier may be arbitrarily selected to be employed from, for example, 840 nm, 1060 nm, 1300 nm, and 1550 nm, according to the intended use of the light source or other factors.

In the present exemplary embodiment, the optical waveguide 102 or 103 may be basically embodied by any waveguide allowing light to travel therethrough. Especially, the optical waveguide 102 or 103 may be embodied by a slab waveguide or an optical fiber that allows light to travel therethrough while keeping the light in confinement to prevent the light from being affected by an external influence as much as possible.

A waveguide, which allows light to travel while confining the light, basically includes a highly reflective portion (core) and a low reflective portion (clad). It is desirable that a resonator has a relatively long length to acquire a narrow FSR interval. In this regard, an optical fiber can function well as a waveguide. This is because a narrower FSR interval allows a user to select an oscillation wavelength from finely set pitches, according to the principle of the dispersion tuning method.

Examples of optical fibers therefor include an optical fiber made of silica (SiO₂) glass, an optical fiber made of plastic, and an optical fiber made of both silica and plastic.

In the present exemplary embodiment, it is effective that chromatic dispersion (wavelength dispersion) occurs in the optical waveguide to achieve tunability of an oscillation wavelength by the dispersion tuning method. The dispersion value of chromatic dispersion may be any predetermined dispersion value from a value of normal dispersion (a negative dispersion value) to a value of abnormal dispersion (a positive dispersion value), and may be arbitrarily selected in consideration of, for example, an employed optical amplifier medium, a target sweep speed, and a sweep wavelength range.

The resonator employable in the present exemplary embodiment may be configured as, for example, a ring resonator in which the respective ends of a gain medium are connected by an optical waveguide such as a fiber, or a linear resonator in which the respective ends of an optical waveguide are constituted by reflective ends (reflective members).

Examples of optical modulators employable in the present exemplary embodiment include a direct modulator capable of electrically modulating a gain of an gain medium directly, a lithium niobate (LN) intensity modulator (using a lithium niobate (LiNbO3) substrate) which is an electrical optical modulator (EOM) using an electro-optical effect (the Pockels effect) as an external modulator, and an electro-absorption optical modulator (EA modulator) using the electro-absorption effect of a semiconductor. Further, another example is an optical modulator such as a cross-gain modulation which introduces signal light to a semiconductor optical amplifier and modulates the intensity of the output light.

In the following, the present invention will be described in further detail with reference to specific exemplary embodiments.

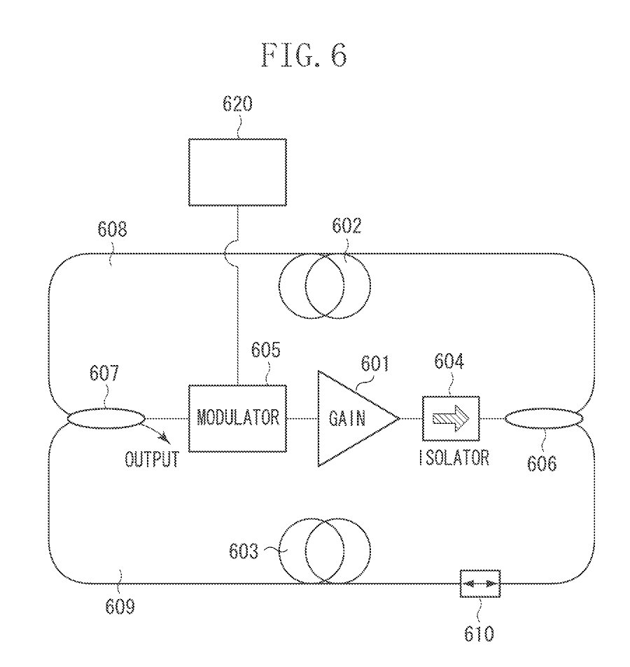

A first exemplary embodiment will be described as an example using a fiber ring resonator. FIG. 6 schematically illustrates a light source apparatus according to the present exemplary embodiment.

In the light source apparatus illustrated in FIG. 6, an optical resonator 608 includes an SOA 601 as an optical gain medium, an optical fiber 602, an isolator 604, an intensity modulator EOM 605, a splitting coupler 606, and a multiplexing coupler 607. Further, an optical resonator 609 includes an optical fiber 603, a fiber stretcher 610, the SOA 601, the isolator 604, the EOM 605, the splitting coupler 606, and the multiplexing coupler 607.

In this way, a fiber double ring resonator is constructed by optically connecting the two optical resonators for the single optical gain medium 601. The multiplexing coupler 607 also functions as an output coupler. A signal generator 620 for modulation is connected to the intensity modulator EOM 605 disposed in the optical resonator. Although a current source is connected to the SOA 601, this current source is omitted from the illustration of FIG. 6.

In the apparatus illustrated in FIG. 6, the optical resonator 608 including the optical fiber 602 and the optical resonator 609 including the optical fiber 603 are configured in such a manner that an optical path length L1 of the optical resonator 608 and an optical path length L2 of the optical resonator 609 are different from each other.

As a result, two different kinds of free spectral range (FSR) intervals are generated in the resonator, and therefore it is possible to acquire pulsed light having a reduced spectral line width according to the above-described principle, compared to pulsed light generated when an active mode locking operation is performed using a single resonator.

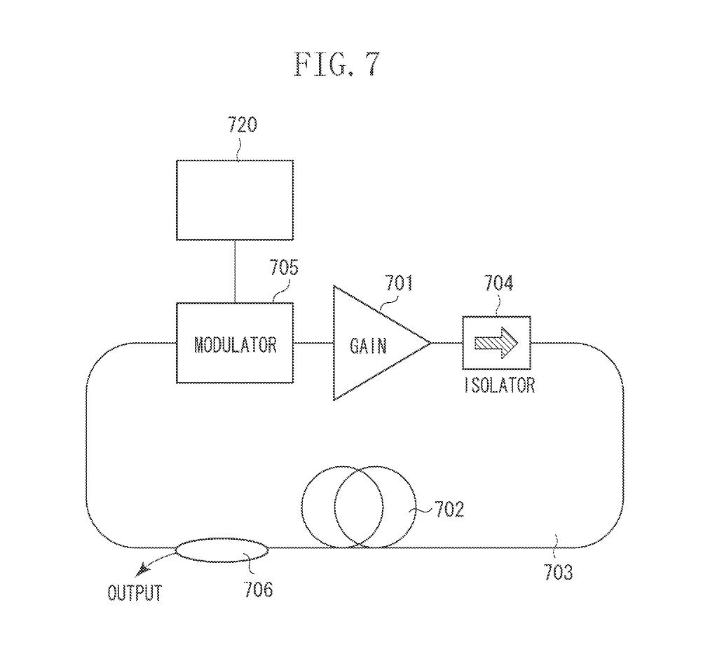

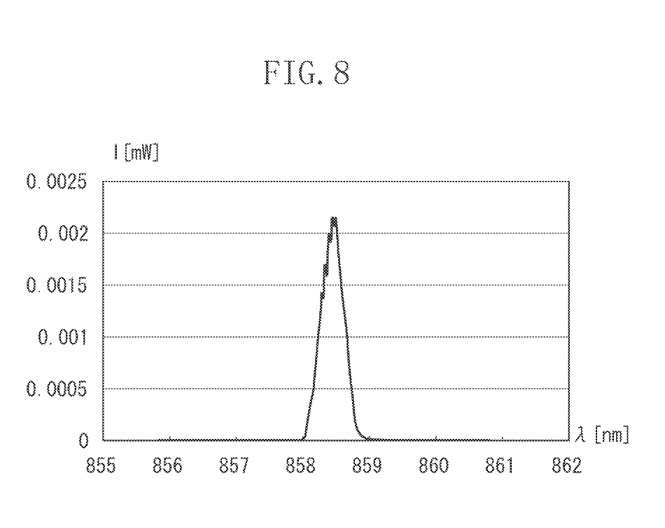

Next, the principle and effects of the present exemplary embodiment will be described. FIG. 7 schematically illustrates a light source apparatus constructed using a single resonator. FIG. 8 illustrates a spectrum of pulsed light generated when an active mode locking operation is performed by the light source apparatus illustrated in FIG. 7. In the light source apparatus illustrated in FIG. 7, an optical resonator 703 includes an optical gain medium (SOA) 701, an optical fiber 702, an optical isolator 704, an EOM 705, which is an LN intensity modulator, and a coupler 706. A signal generator 720 controls the EOM 705.

This light source apparatus uses an optical gain medium having a central frequency of 840 nm as the optical gain medium (SOA) 701, and is configured in such a manner that the resonator 703 using the optical fiber 702 has an optical path length of L1=200 m.

FIG. 8 illustrates a spectrum of pulsed light acquired by an active mode locking operation through application of a modulation frequency of fm1=1.006350 GHz to the EOM 705. The central frequency of the spectrum illustrated in FIG. 8 is λ1=858.4 nm, and the spectral line width (full width at half maximum) is 0.40 nm. According to the principle of dispersion tuning, the oscillation wavelength is changed by changing the modulation frequency fm.

In the apparatus illustrated in FIG. 7, the sensitivity thereof to a wavelength change amount is 0.0542 nm/kHz. This means that a 1 nm change in the wavelength requires changing the mode locking frequency by 1/0.0542=18.45 kHz.

Now, consider the difference between the modulation frequencies fm2 and fm1, in which fm2 represents the modulation frequency when a central wavelength is λ2 away from the oscillating central wavelength λ1 by a half width at half maximum.

According to the above-described sensitivity to a wavelength change amount, and the difference between the central wavelengths (λ2−λ1=0.2 nm), the following answer can be obtained: fm2−fm1=0.2 nm×18.45 kHz/nm=3.69 kHz. Further, assumes that a change in the FSR interval due to the influence of chromatic dispersion is small between the central wavelength and the sideband next thereto, and the frequency interval (the mode locking frequency) between the central wavelength and the next sideband is equal to an integer multiple of the FSR.

Then, according to the above description, in the configuration of the present exemplary embodiment, an offset of the mode locking frequency by 3.69 kHz from the position of the longitudinal mode (the resonator mode) allowed by the resonator can reduce the intensity of the sideband by half.

In this way, even if the position of a sideband to be excited by modulation is offset from the position of a resonator mode, excitation of the sideband is caused due to frequency entrainment, and the intensity of the sideband is reduced as the deviation between the frequencies is increased. In the present exemplary embodiment, assuming that Δfm represents the frequency deviation amount between the sideband to be excited at the half intensity relative to the peak intensity of the central frequency, and the resonator mode, i.e., the frequency entrainment amount (mode locking of a first spectral line width can be acquired), the value of Δfm can be determined as Δfm=3.69 kHz.

The above-described logic can deduct such a conclusion that, if the optical path length L1 of the resonator 608 is 200 min the configuration using the plurality of optical resonators illustrated in FIG. 6, selecting an appropriate length for the optical path length L2 of the resonator 609 to generate this frequency difference Δfm at a position of a wavelength of a desired line width can reduce the intensity of the sideband by half, leading to a reduction in the line width.

As a result, it is possible to acquire a narrower line width than that of the light source apparatus using the single resonator 703 illustrated in FIG. 7.

Now, consider the difference between the lengths L1 and L2 of the resonators (ΔL=L1−L2) to acquire the line width 0.05 nm which is narrower than the line width 0.40 nm. At the frequency 860 nm, the line width 0.05 nm corresponds to 20.28 GHz.

Therefore, a reduction in the line width can be achieved by generating the above-described deviation Δfm=3.69 kHz or so, as the deviation between the sidebands of the resonators 608 and 609 due to the difference between their respective FSRs around a position away from the central frequency by 10.14 GHz which is a half width at half maximum.

The FSR of a resonator can be expressed as FSR=c/nL by using the light speed c and the reflective index n of the resonator. Therefore, the FSR of a resonator using a fiber having a reflective index of n=1.46 and a length of L1=200 m can be acquired as FSR1=1.027 MHz. It should be noted regarding this calculation that the reflective index of a fiber can be used as the reflective index of an optical resonator, since the length of the fiber is significantly longer than an optical gain medium or other elements constituting the optical resonator.

Therefore, there are 980 resonator modes arranged at the FSR1 intervals within the range of fm1=1.006350 GHz, i.e., the interval between the respective sidebands which is equal to the mode locking frequency.

The sideband located around a position away from the central wavelength by 10.14 GHz is the tenth sideband, when a mode locking operation is performed at the frequency fm1=1.006350 GHz.

This means that there are 9800 resonator modes between the central wavelength and the tenth sideband. At this position, a frequency deviation between the longitudinal modes corresponding to Δfm=3.69 kHz can be generated by arranging the resonators 608 and 609 so that they have a difference equal to 0.377 Hz between their FSRs as a difference between a pair of resonator modes, in consideration of the existence of the 9800 resonator modes.

The difference ΔL with which the difference ΔFSR between the FSR1 of the resonator 608 having the optical path length L1 and the FSR2 of the resonator 609 having the optical path length L2 becomes 0.377 Hz can be obtained by using the equation FSR=c/nL, as ΔL≈73 μm.

In the following, the above-described relationship will be expressed by a formula representation. The FSR1 of the resonator 608 having the optical path length L1 and the FSR2 of the resonator 609 having the optical path length L2 are expressed by the following mathematical expression (1).

$$FSR 1 = \frac{c}{{nL}_{1}} , FSR 2 = \frac{c}{{nL}_{2}} \qquad EXPRESSION ( 1 )$$

Assuming that N represents the number of resonator modes (N=9800 in the present exemplary embodiment) that exist from the central frequency to the position where the intensity of the sideband, which determines the spectral line width, is reduced by half in the configuration including a resonator constituted by a single resonator, the lower limit of ΔFSR=FSR1−FSR2 can be determined and expressed by the following mathematical expression (2).

$$\frac{Δ fm}{N} \leq Δ FSR \qquad EXPRESSION ( 2 )$$

In this mathematical expression, it can be considered that N also represents the number of longitudinal modes that exist from the central frequency acquired by a plurality of optical resonators to the position where a reduced second spectral line width is located on the frequency axis.

This indicates that, if LFSR satisfies the expression (2), the spectral line width can be reduced compared to the configuration using a single resonator.

Further, if ΔFSR becomes Δfm at the position of the sideband next to the central frequency, i.e., the sideband immediately next to the central frequency, the mode locking operation cannot be stabilized, since the intensity of the excited sideband is weak, and the number of sidebands is small. From this fact, the upper limit of ΔFSR can be determined and expressed by the following mathematical expression (3).

$$Δ FSR \leq \frac{Δ fm}{{N}_{1}} \qquad EXPRESSION ( 3 )$$

Therefore, the expressions (2) and (3) lead to determination of the ranges of L1 and L2 that satisfy the requirements of the present exemplary embodiment, which can be expressed by the following mathematical expression (4).

$$\frac{Δ fm}{N} \leq \frac{c}{{nL}_{1}} - \frac{c}{{nL}_{2}} \leq \frac{Δ fm}{{N}_{1}} \qquad EXPRESSION ( 4 )$$

In this mathematical expression, N1 represents the number of longitudinal modes allowed by the resonator, which exist between the central frequency and the position of the sideband immediately next to the central frequency in an active mode locking operation.

If a resonator is constituted by three or more resonators, since ΔFSR is determined from a combination of resonators that have a largest difference between optical path lengths, the effect of the present exemplary embodiment can be achieved by respectively setting L1 and L2 as the optical path lengths of the resonators constituting such a combination.

In other words, if a plurality of resonators is combined to constitute a single resonator, two optical resonators that have a largest difference between the optical path lengths of the individual resonators are selected, and L1 and L2 are set as the optical path lengths of these resonators. L1 and L2 can be selected in such a manner that they satisfy the above-described expression (4).

The difference between optical path lengths according to the present exemplary embodiment can be generated, for example, by using the resonators of L1 and L2 made of a same kind of fibers, and using a fiber stretcher. Further, it is also possible to adjust the spectral line width of oscillation pulsed light by changing the resonator length difference ΔL by using a fiber stretcher.

As a result, the spectral line width can be reduced to 0.05 nm in the light source apparatus according to the present exemplary embodiment illustrated in FIG. 6, compared to the line width 0.40 nm in the configuration using a single resonator.

In other words, it is possible to reduce the spectral line width of oscillation pulsed light during an active mode locking operation with a simple configuration.

Examples of methods for generating the above-described difference between optical path lengths include a delay line using a piezoelectric element or a reflective index tunable waveguide, a space-optical delay line, and a variable delay line using a temperature change, in addition to the fiber stretcher used as an example in the present exemplary embodiment.

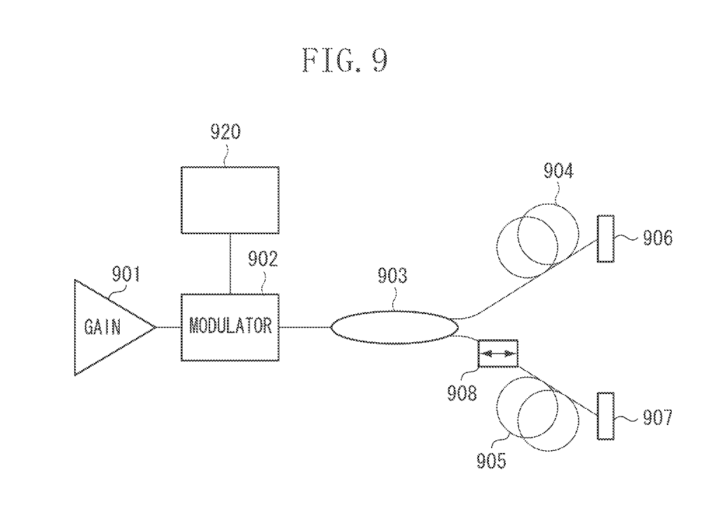

A second exemplary embodiment will be described as an example of a linear resonator constructed by using an optical fiber. FIG. 9 schematically illustrates a light source apparatus according to the present exemplary embodiment.

In the light source apparatus illustrated in FIG. 9, a linear resonator includes a reflective SOA 901 as an optical gain medium, an EOM 902, a splitting/multiplexing coupler 903, optical fibers 904 and 905, reflection mirrors 906 and 907, and a fiber stretcher 908. A signal generator 920 controls the EOM 902.

The reflective SOA 901 and the reflection mirror 906 constitute a first resonator, and the reflective SOA 901 and the reflection mirror 907 constitute a second resonator.

As is the case with the first exemplary embodiment, a desired line width can be acquired by adjusting the difference between the optical path lengths by using the fiber stretcher 908, and the line width can be reduced compared to a light source apparatus using a single resonator. The present exemplary embodiment is a linear resonator, and therefore does not need an isolator, which is an advantageous feature in terms of cost.

The present exemplary embodiment has been described as a Y-shaped resonator having a branch point at a position along the linear resonator. However, the present exemplary embodiment may be also configured as a linear resonator in the form of a single line without a branch point.

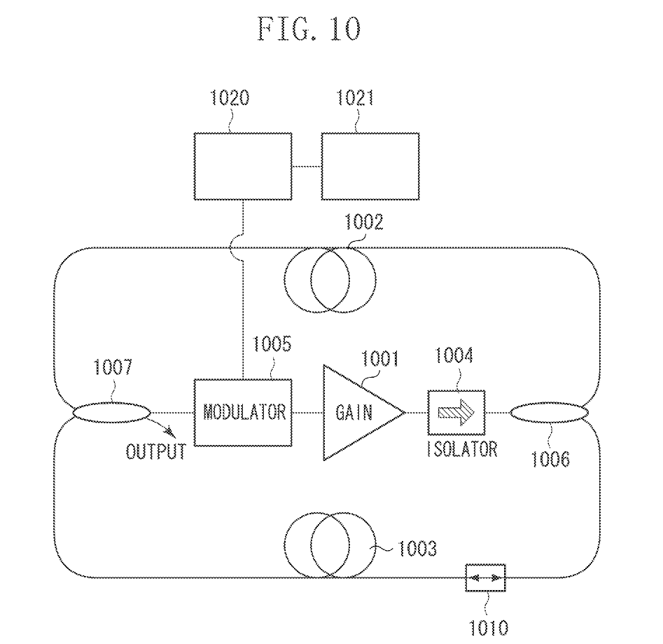

A third exemplary embodiment will be described as an example of a wavelength tunable light source apparatus constructed by using a light source apparatus capable of reducing a line width of pulsed light according to an exemplary embodiment of the present invention. FIG. 10 schematically illustrates a wavelength tunable light source apparatus according to the present third exemplary embodiment.

In the wavelength tunable light source apparatus illustrated in FIG. 10, a fiber double ring resonator includes an SOA 1001, optical fibers 1002 and 1003, an optical isolator 1004, an EOM 1005, a splitting coupler 1006, a multiplexing coupler 1007, and a fiber stretcher 1010, which are optically connected to one another. A signal generator 1020 controls the EOM 1005. A signal generator 1021 generates a signal for frequency modulation (FM).

This light source apparatus performs intensity modulation by driving the EOM 1005 at a frequency equal to an integer multiple of the FSR interval determined by the resonator length, for performing an active mode locking operation.

In this active mode locking state, a modulation frequency is FM modulated by using the signal generator 1021 to cause sweeping of an oscillation wavelength, to construct a swept wavelength light source based on the operating principle of dispersion tuning.

The operating principle of dispersion tuning will be described below. When an optical waveguide included in an optical resonator has chromatic dispersion of a reflective index, the FSR interval varies depending on a wavelength. Therefore, a wavelength tunable light source can be realized by changing a modulation frequency to cause a change in the central frequency of pulsed light generated by a mode locking operation.

If the value of reflective index dispersion in an optical resonator does not exceed a certain value, a sufficient wavelength tunable characteristic cannot be obtained. In other words, even if a modulation frequency is changed, this can only make a slight change in the oscillation frequency. In addition, the wavelength of the oscillation peak also satisfies the condition for the mode locking operation at the same time, resulting in generation of pulsed light having a wide spectral line width. This is not desirable in terms of an S/N ratio as a light source for measurement use.

More specifically, for an optical resonator constructed by using an optical fiber in a system of a wavelength region of 1.0 μm, typically, the chromatic dispersion of the optical fiber is −50 (ps/nm km). At this time, a fiber length shorter than 10 m deteriorates the wavelength tunable characteristic. Therefore, the absolute value of the minimum required chromatic dispersion amount in an optical resonator is 0.5 (ps/nm). Accordingly, tuning dispersion can work well in a case that the absolute value of the sum of reflective index dispersion in an optical resonator is 0.5 (ps/nm) or larger.

Further, it is desirable that the fiber length is 50 m or longer to acquire a more excellent wavelength tunable characteristic. In other words, it is desirable that the absolute value of the chromatic dispersion amount in the optical resonator is 2.5 (ps/nm) or larger.

It is possible to reduce the spectral line width by employing the light source apparatus including the plurality of resonators according to the exemplary embodiment of the present invention due to the principle mentioned in the description of the first exemplary embodiment. Then, it is possible to reduce the line width with a simple method even in a wavelength tunable light source based on the dispersion tuning method which would be otherwise difficult to have a reduction in the line width according to the operating principle of active mode locking. Therefore, it is possible to improve resolution during data acquisition by using the present exemplary embodiment as a wavelength tunable light source for various kinds of measurement.

The present exemplary embodiment has been described as a wavelength tunable light source apparatus constructed by using a plurality of ring resonators. However, the present exemplary embodiment may be configured as a light source apparatus with use of Y-shaped resonators or linear resonators, instead of ring resonators.

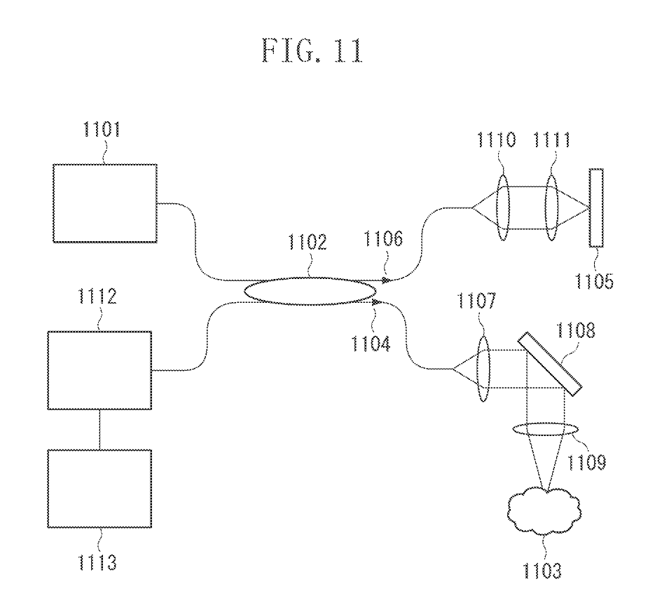

A fourth exemplary embodiment will be described as an example of employing a wavelength tunable light apparatus to a swept-source optical coherence tomography (SS-OCT). FIG. 11 schematically illustrates a swept-source optical coherence tomography to which a wavelength tunable light source apparatus according to the present exemplary embodiment is employed.

The OCT apparatus illustrated in FIG. 11 splits light emitted from a wavelength tunable light source 1101 (light source unit) through a coupler 1102 into sample light 1104 to be guided to a subject 1103, and reference light 1106 to be guided to a stationary mirror (reference mirror) 1105. After the split, the sample light 1104 is guided to the subject 1103 via a collimator lens 1107, a scanning mirror 1108, and an objective lens 1109, and then the subject 1103 is irradiated with the sample light 1104.

The reflected light carrying depth information of the subject 1103 returns through the same optical path, and reaches the coupler 1102 again. The objective lens 1109, the scanning mirror 1108, and the collimator lens 1107 constitute a subject measurement unit.

On the other hand, the reference light 1106 is reflected by the stationary mirror (reference mirror) 1105 after being transmitted through the collimator lens 1110 and the objective lens 1111, and returns through the same optical path to reach the coupler 1102 (interference unit) again. The reference mirror 1105, the objective mirror 1111, and the collimator lens 1110 constitute a reference unit, and transmit the reflected light to the interference unit 1102.

After the reference light 1106 returns to the interference unit 1102, the reference light 1106 is guided to a photodiode (optical detection unit) 1112 together with the sample light (reflected light) 1104 to generate an interference signal. A calculation processing unit (image processing unit) 1113 rearranges this interference signal based on a light source scanning signal, and applies signal processing mainly constituted by Fourier transform, as a result of which a depth-direction tomographic image can be acquired. In other words, a tomogram of the subject 1103 can be acquired based on the interference light detected by the optical detection unit 1112.

The present exemplary embodiment employs the wavelength tunable light source according to the present invention, as the wavelength tunable light source 1101. As a result, the present exemplary embodiment can use pulsed light having a reduced line width for measurement, and facilitate wavelength separation at each data acquisition point, to acquire an OCT image with an improved S/N ratio.

Next, the effect regarding measurement depth will be described below. Assuming that CL represents a coherence length of an OCT apparatus, λ0 represents a central frequency of an oscillation wavelength, and σλ represents a line width of laser light, the following mathematical expression (5) can be established:

CL=(21n2/π)(λ02/σλ) EXPRESSION (5)

According to the description of the first exemplary embodiment, the spectral line width σλ of the light source apparatus according to the present exemplary embodiment is a one-eighth (0.05 nm/0.40 nm) of that of an apparatus using a single resonator, and therefore the coherence length CL is eight times longer than that of an apparatus using a single resonator. Ignoring influences of light scattering against or absorption into the subject 1103, the measurement depth of an OCT apparatus can be obtained as a half of the coherence length CL. Therefore, in principle, the present exemplary embodiment can provide the excellent effect of improving the measurement depth up to approximately four times (8/2) greater than that of an apparatus using a single resonator.

A fifth exemplary embodiment will be described as an example of employing a swept wavelength light source according to the present invention to a stimulated Raman scattering (SRS) microscope. A stimulated Raman scattering microscope (SRS microscope) is a microscope apparatus that uses two pulsed light beams having different wavelengths, synchronously applies the two pulsed light beams onto a specimen after performing intensity modulation to one of the two pulsed light beams to induce an SRS phenomenon, which is a nonlinear optical effect, and observes a transfer of the intensity modulation of the one light beam to the other light beam as a signal.

In this microscope, an SRS phenomenon occurs when a difference frequency between the two wavelengths coincides with the molecular vibration frequency of molecules constituting a measurement specimen. Therefore, it is possible to match the difference frequency with molecular vibration frequencies of various molecules by changing the central frequency of the one pulsed light beam, and it is possible to obtain a signal specific to the molecule group constituting the specimen. In this way, the present exemplary embodiment is a highly-sensitive and high-resolution microscope apparatus capable of providing non-invasive cellular observation without requiring staining a specimen, mainly targeting at a living specimen.

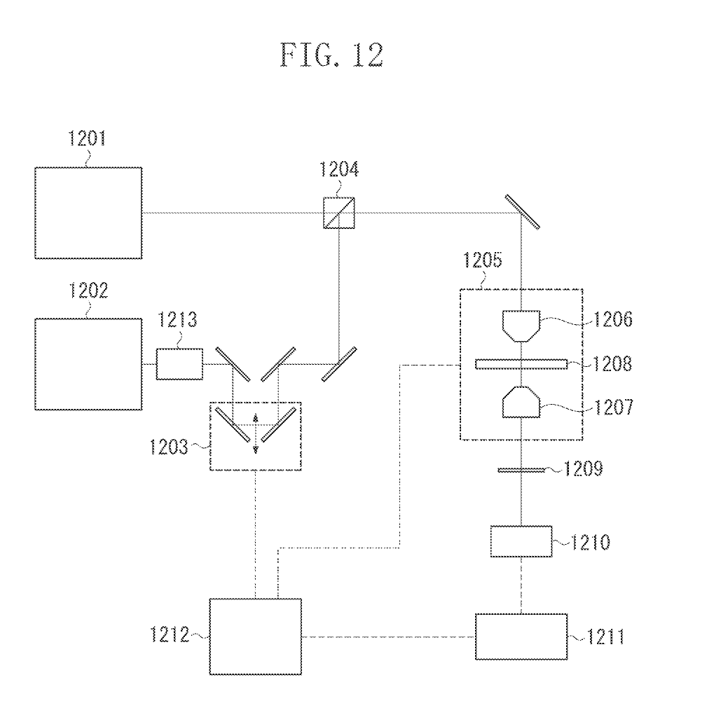

FIG. 12 illustrates an example of such a SRS microscope apparatus to which a swept-wavelength light source according to the present invention is employed. The microscope apparatus illustrated in FIG. 12 uses a swept wavelength light source 1201 configured to emit pulsed light with a repetition frequency of f1 and a central wavelength of λ1, and a light source 1202 configured to emit pulsed light with a repetition frequency of f2 equal to f1 (=f1) and a central wavelength of λ2 (a central wavelength different from that of the light source 1201). The swept wavelength light source 1201 is the light source according to the present invention.

The pulsed light emitted from the light source 1202 receives intensity modulation by an intensity modulator 1213, and is transmitted to a specimen via a delay line 1203, which is configured to change the optical path length, at illumination timing adjusted so as to be synchronized with the pulsed light emitted from the light source 1201.

The pulsed light beams emitted from the two light sources 1201 and 1202 are multiplexed by a multiplexing unit 1204, which is configured to multiplex them, and is guided through a same optical path. After that, the light is applied and condensed onto a specimen placed on a stage 1208, which is configured to hold the measurement specimen, by objective lenses 1206 and 1207 in a measurement unit 1205.

The light containing a stimulated Raman scattering signal (SRS signal) component generated from the measurement specimen is transmitted through a filter (optical filter) 1209, and only the light of λ1 is measured by a photo detector 1210. At this time, the stimulated Raman signal component is extracted by the filter 1209. Then, a signal detection unit (lock-in amplifier included) 1211 applies lock-in detection to the light, and a calculation unit 1212 applies signal processing and image formation thereto.

Further, the calculation unit 1212 controls the delay line 1203 to synchronize the timing of illuminating the specimen with the two pulsed light beams so as to generate an optimized image. Further, the calculation unit 1212 transmits a signal to a unit for controlling a position of the specimen or a beam position on the measurement unit 1205 of the microscope apparatus to control it, and acquires a two-dimensional or three-dimensional image.

The repetition frequencies from the two light sources 1201 and 1202 may be f1=f2, or may be in such a relationship that one of them is an integer multiple of the other of them (f1=m×f2 or m×f1=f2 in which m is an integer). This configuration is advantageous since an SRS signal can be acquired without providing an intensity modulator.

It should be noted that the light source that emits pulsed light to be intensity-modulated, and the light source that has a repetition frequency equal to 1/integer of the repetition frequency of the other are not limited to the combination in the present exemplary embodiment. The difference frequency of the central wavelengths of the pulsed light beams emitted from the two light sources 1201 and 1202 may be approximately 500 to 3500 cm-1 so as to be equal to a molecular vibration frequency of a molecule constituting a living cell. More specifically, the wavelength λ1 of the light source 1201 may be tunable from approximately 750 nm to 950 nm, and the wavelength λ2 of the light source 1202 may be approximately 1020 nm.

Further, it is desirable that the repetition frequencies f1 and f2 of the light sources 1201 and 1202 are several MHz or more to achieve high sensitivity by lock-in detection. Such a light source can be constructed with use of a fiber laser using an SOA or a rare-earth doped fiber as a gain medium.

As desired characteristics for a light source of an SRS microscope, the light source is desired to provide a repetition frequency of several MHz or more, and a high wavelength tuning speed to increase an image acquisition speed.

In this respect, dispersion tuning, which is the operating principle of the swept wavelength light source according to the present invention, is basically an active mode locking operation, and can be used as alight source satisfying the repetition frequency, and the wavelength tuning speed.

Further, use of the swept wavelength light source according to the present invention is advantageous, since it enables measurement of a specimen with light having a narrow spectral line width, and can achieve improvement in the resolution of an SRS signal in terms of light separation and construction of an SRS microscope capable of acquiring a high definition image.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-260528 filed Nov. 22, 2010, which is hereby incorporated by reference herein in its entirety.

What is claimed is:

1. A light source apparatus that emits pulsed light from an optical resonator, comprising:
the optical resonator including an optical gain medium configured to amplify light, and an optical waveguide; and
a modulator configured to modulate an intensity of the light in the optical resonator, and
wherein the optical resonator provided with the optical gain medium includes a plurality of optical resonators having different optical path lengths from each other to make a difference between intervals of free spectral ranges in the plurality of optical resonators, to reduce a spectral line width of the pulsed light compared to that of a light source apparatus separately using the plurality of optical resonators as an individual optical resonator, the spectral line width determined by an envelope formed by a sideband wave of an oscillation mode which is generated by the modulation.

2. The light source apparatus according to claim 1, wherein the light source apparatus acquires active mode locking by applying a modulation frequency equal to an integer multiple of the free spectral range by the modulator.

3. The light source apparatus according to claim 2, wherein the light source apparatus is configured to satisfy the following mathematical expression 1:
$$\frac{Δ fm}{N} \leq \frac{c}{{nL}_{1}} - \frac{c}{{nL}_{2}} \leq \frac{Δ fm}{{N}_{1}} \qquad [ EXPRESSION 1 ]$$
wherein Δfm represents a value of frequency entrainment for causing an active mode locking operation to acquire a first spectral line width in the optical resonator comprising the individual optical resonators,
N represents the number of longitudinal modes allowed by the plurality of optical resonators, which exist from a central frequency acquired by the plurality of optical resonators to a position of a second spectral line width on a frequency axis, the second spectral line width being acquired by the reduction,
N1 represents the number of longitudinal modes allowed by the plurality of optical resonators, which exist from the central frequency to a position of a sideband generated during the active mode locking operation and located next to the central frequency,
n represents a reflective index of the optical resonator,
c represents a light speed, and
L1 and L2 respectively represent optical path lengths of two optical resonators that have a largest difference between the optical path lengths thereof among the individual optical resonators constituting the plurality of optical resonators.

4. The light source apparatus according to claim 1, wherein the optical waveguide included in the optical resonator has reflective index dispersion, and an oscillation wavelength varies depending on a modulation frequency of the modulator.

5. The light source apparatus according to claim 4, wherein an absolute value of a sum of the reflective index dispersion of the optical resonator has a value equal to or larger than 0.5 (ps/nm).

6. The light source apparatus according to claim 1, wherein the optical waveguide is configured by an optical fiber.

7. The light source apparatus according to claim 1, wherein the optical resonator is a ring resonator.

8. The light source apparatus according to claim 1, wherein the optical resonator is a linear resonator including reflective members disposed at the both ends of the optical resonator.

9. The light source apparatus according to claim 1, wherein the optical resonator is a Y-shaped resonator.

10. The light source apparatus according to claim 1, wherein at least one of the plurality of optical resonators includes a unit for changing the optical path length.

11. The light source apparatus according to claim 10, wherein the unit for changing the optical path length is a variable delay line.

12. The light source apparatus according to claim 1, wherein the modulator is a unit configured to modulate a gain of the optical gain medium.

13. The light source apparatus according to claim 1, wherein the modulator is an intensity modulator disposed in the optical resonator.

14. An optical coherence tomographic apparatus comprising:
a light source unit including the light source apparatus according to claim 1;
a subject measurement unit configured to illuminate a subject with light emitted from the light source unit, and transfer reflected light from the subject;
a reference unit configured to transmit the light emitted from the light source unit to a reference mirror, and transfer reflected light from the reference mirror;
an interference unit configured to cause interference between the reflected light from the subject measurement unit and the reflected light from the reference unit;
an optical detection unit configured to detect interference light from the interference unit; and
an image processing unit configured to acquire a tomogram of the subject based on the light detected by the optical detection unit.

15. A stimulated Raman scattering microscope apparatus comprising:
a first light source unit including the light source apparatus according to claim 1;
a second light source unit configured to emit pulsed light having a central wavelength different from a central wavelength of pulsed light emitted from the first light source unit;
a multiplexing unit configured to multiplex these two pulsed light beams;
an objective lens;
a stage configured to hold a measurement specimen;
a filter configured to extract a stimulated Raman signal component;
a light receiver;
a signal detector; and
a signal processing unit.
